(19) United States
(12) Patent Application Publication
(10) Pub. No.: US 2012/0282909 A1
(43) Pub. Date: Nov. 8, 2012

(54) WIMAX FEMTO NETWORK SUPPORT FOR WIMAX FEMTO CONFIGURATION MANAGEMENT

(75) Inventors: Wen Luo, Nanjing (CN); Jianquan Song, Shenzhen (CN); Tricci So, San Diego, CA (US); Li Chu, Shenzhen (CN); Yangwei Tu, Nanjing (CN); JunSheng Chu, Nanjing (CN)

(73) Assignees: ZTE (USA) INC., Richardson, TX (US); ZTE Corporation, Shenzhen (CN)

(21) Appl. No.: 13/504,425

(22) PCT Filed: Oct. 28, 2010
(86) PCT No.: PCT/US10/54373

§ 371 Date: Jul. 16, 2012

Related U.S. Application Data
(60) Provisional application No. 61/255,679, filed on Oct. 28, 2009.
(60) Provisional application No. 61/286,269, filed on Dec. 14, 2009.

(51) Int. Cl. H04W 16/00

(52) U.S. Cl. 455/418

(57) ABSTRACT

Embodiments of the present invention relate to wireless communication and, more specifically, to network support for configuration management in a Worldwide Interoperability Microwave Access Femto Network. In one exemplary embodiment, offline and/or updated configuration information is obtained by a WiMAX Femto Access Point from a management server whether the WiMAX Femto Access Point is active or inactive and before or after initial network entry. Configuration information synchronization may also be performed before or after initial network entry.

### PRIORITY

Priority is claimed under 35 U.S.C. §119 to U.S. Provisional Patent Application No. 61/255,679, filed Oct. 28, 2009, and to U.S. Provisional Patent Application No. 61/286,269, filed Dec. 14, 2009. The disclosures of the aforementioned priority applications are incorporated herein by reference in their entirety.

### FIELD OF THE INVENTION

The field of the present invention relates to wireless communication and more specifically to network support for configuration management in a Worldwide Interoperability Microwave Access (WiMAX) Femto Network.

### BACKGROUND

A WiMAX Femto Access Point (WFAP) is generally a low power WiMAX Base Station, operating in a licensed band and intended to: be end-user installed without service provider manual configuration (e.g., plug and play); provide service for a limited number of concurrent users over small areas such as the home, the small office, home office (SOHO), and the enterprise environments; use a shared broadband connection for backhaul that may be operated by a different Service Provider; and support limited user mobility (i.e., low speed, infrequent need for handover).

Generally, the WFAP is connected to Femto Gateway and other functional entities in a network through an IP Security tunnel provided by Security Gateway, which is responsible for authentication and supporting authorization of the WFAP. The Femto Gateway generally controls WFAP(s) and performs transmission of user data packets to Core Service Network. WFAP management includes configuration management which involves setting and changing attributes for proper network operations. A Closed Subscriber Group (CSG) is generally a set of users authorized by the FemtoCell subscriber and/or WFAP service provider to have reserved/privileged access to WiMAX services through a particular WEAR

### SUMMARY OF THE INVENTION

Certain embodiments of the present invention are directed to modifying the WFAP initial network entry (INE) procedure to obtain configuration information that is configured “offline”, i.e. without an active network connection. Certain embodiments of the present invention are also directed to how the WFAP obtains “updated” configuration information periodically from the Femto Management Server for the offline configuration. One example of this offline configuration is the offline CSG configuration. That is, CSG configuration information is an example of configuration information.

According to certain embodiments of the invention, for online configuration the configuration is performed at the WFAP (e.g., via local graphical user interface (GUI) interface in the WFAP) prior to the configuration being sent to the Femto Management Server to process (e.g., CSG Online Configuration). According to certain embodiments of the invention, for offline configuration the configuration may be performed at Femto Management Server (e.g., WFAP owner calls the Femto network service provider (NSP), Website registry, and the like) prior to the configuration information being downloaded to the WFAP, if required, as soon as the WFAP goes online and is ready to accept configuration (e.g., CSG Offline Configuration).

According to certain embodiments of the invention, for both online and offline Configuration the final confirmation is from the Femto Management Server. Only if the configuration is accepted by the Femto Management Server, the configuration information will be downloaded to the WFAP, if required, as soon as the WFAP goes online and is ready to accept configuration.

According to certain embodiments of the invention, the offline configuration can happen when the corresponding WFAP is either active (i.e., after WFAP performs initial network entry and is operational) or inactive (i.e., before WFAP performs initial network entry and/or WFAP is not operational). The Configuration Information Synchronization can be done during the WFAP INE, and can also be done after the WFAP INE, for example.

According to certain embodiments of the invention, regardless of whether the WFAP is inactive or active, the offline configuration can happen at the Management Server. As a result, the new configured information is stored in Management Server and the configuration is not available for the WFAP until it is synchronized with the Management Server. Eventually, the configured information may need to be synchronized between the Management Server and the WFAP. One example of this configuration information could be the CSG Configuration Information. Moreover, all the configuration information mentioned above may be the CSG Configuration Information. The CSG Configuration Information at least may include a CSG member list for this WFAP and also could include other information related to CSG Configuration.

### BRIEF DESCRIPTION OF THE DRAWINGS

A more complete understanding of certain embodiments of the present invention may be realized by reference to the accompanying drawings, which are not necessarily drawn to scale.

FIG. 1 illustrates an embodiment of how configuration synchronization is performed after WFAP INE.

FIG. 2 illustrates an embodiment of how configuration synchronization is performed after WFAP INE.

FIG. 3 illustrates an embodiment of how configuration synchronization is performed after WFAP INE.

FIG. 4 illustrates an embodiment of how configuration synchronization is performed after WFAP INE with periodic updates from mgmt server to WFAP.

FIG. 5 illustrates an embodiment of how configuration synchronization is performed after WFAP INE with periodic updates from mgmt server to WFAP.

FIG. 6 illustrates an embodiment of how configuration synchronization is performed during the WFAP INE.

FIG. 7 illustrates an embodiment of how configuration synchronization is performed after the WFAP INE.

FIG. 8 illustrates another embodiment of how configuration synchronization is performed after the WFAP INE.

FIG. 9 illustrates an embodiment of how configuration synchronization is performed during the WFAP INE.

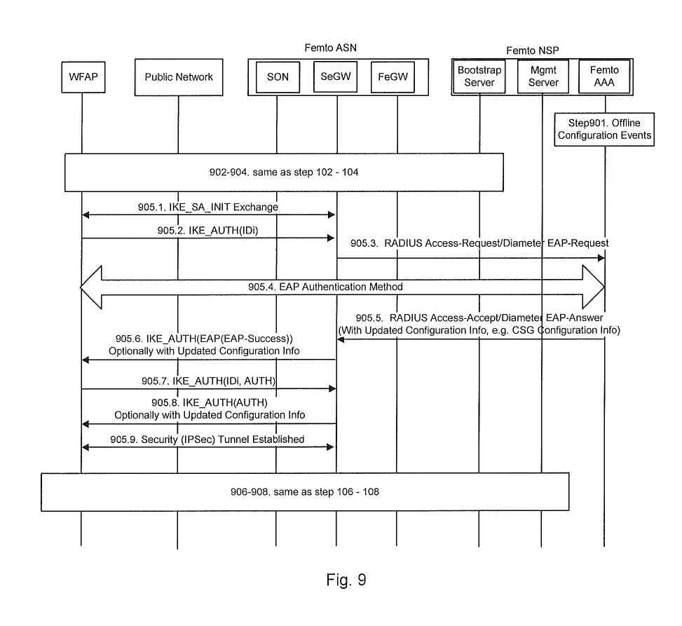

FIG. 10 illustrates an embodiment of a system in which embodiments of the present invention may be implemented.

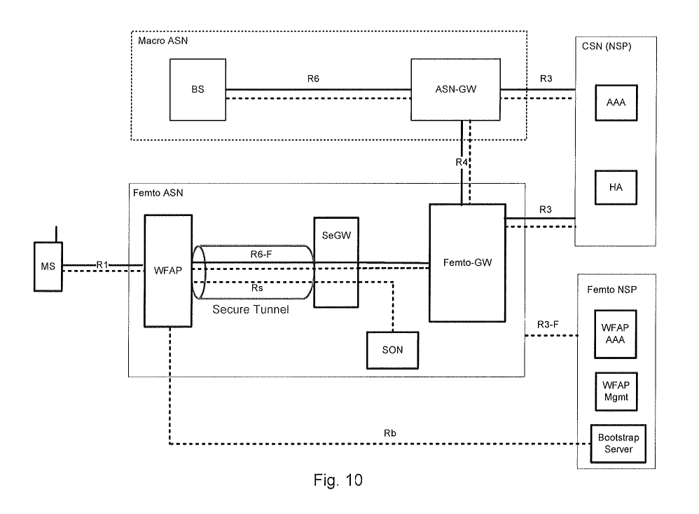

### DETAILED DESCRIPTION OF THE PREFERRED EMBODIMENT

Hereinafter, various embodiments of the present invention are described in detail with reference to the attached drawings. In the drawings, well-known elements, in the relevant art, have been omitted in order not to obscure the present invention in unnecessary detail.

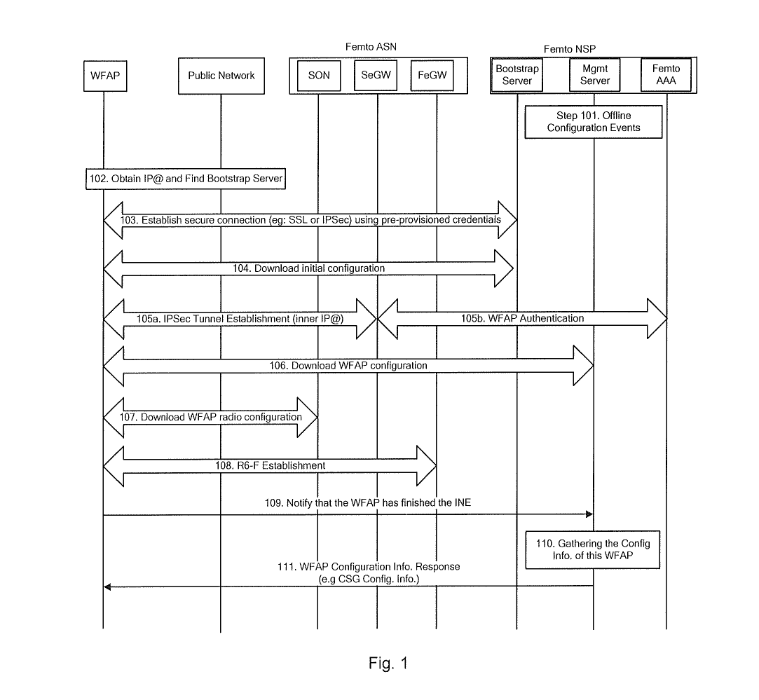

Referring to FIG. 1, in Step 101, offline configuration events could happen at any time when the WFAP is inactive (i.e., before WFAP performing INE and/or WFAP is not operational). One example of this configuration event is offline CSG configuration. However, the Management Server may always store the configured information in the management database.

In Step 102, The WFAP is booted up. The WFAP obtains the (outer) internet protocol (IP) address from the public backhaul network (e.g., DSL, Cable) via Dynamic Host Configuration Protocol (DHCP). If the WFAP does not have a pre-provisioned fully qualified domain name (FQDN) of the bootstrap server, the IP address of this bootstrap server may be provided as a DHCP option. If the WFAP is pre-provisioned with the FQDN of the bootstrap server, the WFAP may perform a Domain Name Server (DNS) query for the IP address of the bootstrap server in the Femto NSP.

In Step 103, once the IP address of the bootstrap server is determined by the WFAP, the WFAP establishes secure connection with the bootstrap server. This secure connection may be bootstrapped by pre-provisioned credentials.

In Step 104, the WFAP connects to the bootstrap server and request initial configuration information. The WFAP may provide its IP address and location information (e.g., GPS info) so that the appropriate Security Gateway (Se-GW) can be selected for the WFAP by the bootstrap server. The bootstrap server may contact the Location Server (LS) for the location determination of the WFAP. The WFAP may obtain the IP address of Se-GW from the bootstrap server. In addition the WFAP may also obtain the FQDN of the management server.

In Step 105, the WFAP establishes IP Security (IPSec) tunnel with the Se-GW and WFAP authentication is performed. The Se-GW may relay Extensible Authentication Protocol (EAP) messages to Femto authentication, authorization and accounting (AAA) for the authentication of the WFAP. The inner IP address may also be assigned to WFAP by the default Se-GW.

In Step 106, the WFAP connects to the management server, The WFAP may send its local information to the management server such as the IP address of WFAP, hardware serial number (HW S/N), software (S/W) version, location information, and the like. Based on the provided information by WFAP, the management server may provide the higher layer configuration parameters to the WFAP. Along with these parameters, either the FQDN or the IP address of the self-organizing network (SON) server may be returned to the WFAP. Moreover, the WFAP can trigger a DNS query to find the management server address, based on the FQDN of the management server.

In Step 107, the WFAP connects to the SON server and the WFAP sends its local information to the SON server. The location of the WFAP may be authorized by the SON server. Based on the provided information by WFAP, the SON server may provide the PHY/MAC configuration parameters to the WFAP and authorize the WFAP to turn on the radio transmission. The SON server also may provide the IP address of the Femto Gateway (Fe-GW) that the WFAP may attach to. Moreover, the WFAP can trigger a DNS query to find the SON server address, based on the FQDN of the SON server.

In Step 108, the WFAP establishes an R6-F data path with the Fe-GW (i.e., WFAP register with the Fe-GW).

Steps 102-108 could be identified as WFAP INE PROCEDURE.

In Step 109, after Step 108, i.e., the WFAP has successfully registered with Femto-GW; the WFAP sends a message to the Management Server (WFAP management server) to indicate that the WFAP INE (initial network entry) is completed. This indication may signify that the WFAP is now operational to serve subscriber.

In Step 110, when the Management Server receives the indication that WFAP INE is completed, the Management Server may keep this status information. The Management Server then obtains the Configuration Information which is configured “offline” for this WFAP.

In Step 111, the Management Server delivers the Configuration Information mentioned in Step 110 to the WFAP. Note that, the Configuration Information mentioned in Step 101-Step 111 above could be the CSG configuration information. Also note that, the successful R6-F data path establishment (i.e., successful Fe-GW registration) as described above indicates that the WFAP INE is completed.

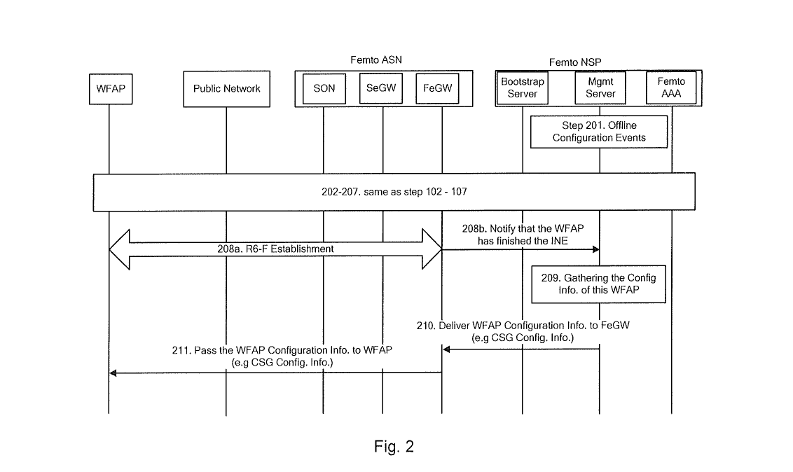

Alternatively, in Step 108, when the R6-F data path is established with the given WFAP (i.e., the WFAP has registered with Fe-GW successfully), the Fe-GW can send this message to the Management Server to indicate such event. In such a case, as shown in Step 210 of FIG. 2, the Management Server would deliver the Configuration Information to the Fe-GW, and the Fe-GW will then relay the information to the WFAP.

Referring to FIG. 2, Steps 201-207 are identical to Steps 101-107 as illustrated in FIG. 1.

In Step 208a, the WFAP establishes an R6-F data path with the Fe-GW.

In Step 208b, after the R6-F data path between WFAP and Fe-GW has been successfully established (i.e., successful Fe-GW registration), the Fe-GW sends a message to the Management Server to indicate that the WFAP INE is completed. This event may indicate that the WFAP is now operational to serve subscriber.

Step 209 is identical to Step 110 as illustrated in FIG. 1.

In Step 210, Management Server delivers the Configuration Information of this WFAP to Fe-GW.

In Step 211, Fe-GW further passes this WFAP Configuration Information to WFAP. The configuration information mentioned in Steps 201-211 above could be the CSG configuration information.

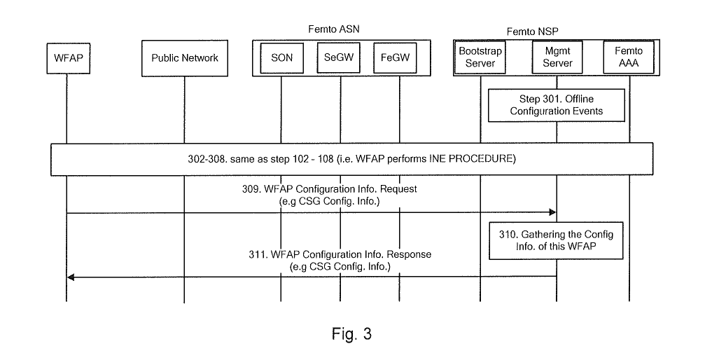

Referring to FIG. 3, in Step 301, offline configuration events could happen at any time when the WFAP is inactive (i.e., before WFAP performing INE and/or WFAP is not operational). One example of this configuration event could be the offline CSG configuration. However, the Management Server stores the configured information in the management database.

Steps 302-308 are identical to Steps 102-108 as illustrated in FIG. 1 (i.e., WFAP INE PROCEDURE).

In Step 309, after the R6-F data path between WFAP and Fe-GW has been successfully established (i.e., successful Fe-GW registration), the WFAP sends a message to the Management Server to request the latest Configuration Information. Additionally, this message could also be an indication that the WFAP INE is completed.

In Step 310, when receiving the request form WFAP, the Management Server picks-up/retrieves the Configuration Information that is configured “offline” for this WFAP.

In Step 311, the Management Server delivers the Configuration Information mentioned in Step 310 to the WFAP to update the Configuration Information stored in the WFAP.

Alternatively, in Step 309, the WFAP sends the request to the Femto-GW, and then the Femto-GW forwards the request to the Management Server. In such a case, in Step 311, the Management Server responds with the Configuration Information to the Fe-GW, and then the Fe-GW relays this configuration response to the WFAP. The Configuration Information mentioned in Steps 301-311 above could be the CSG configuration information.

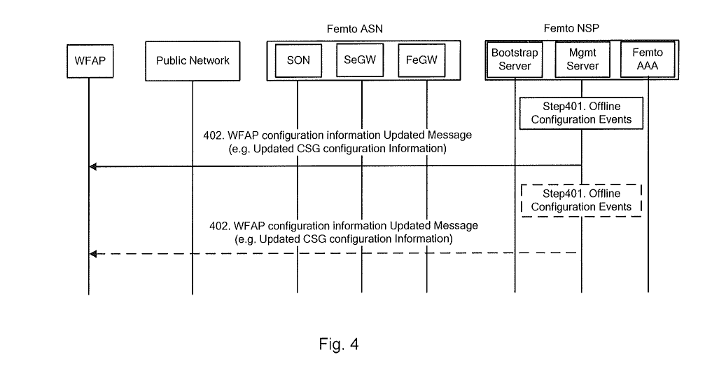

Referring to FIG. 4, in Step 401, offline configuration events could happen any time when the WFAP is active or inactive. One example of this configuration event is the offline CSG configuration.

In Step 402, when the WFAP is active (i.e., after WFAP performing INE and is operational), the Management Server delivers this updated configuration information, which is configured offline, to WFAP in corresponding message used between the Management Server and the WFAP in the timely manner to support the required operation. Whenever periodic updates are needed from the Management Server to the WFAP, the Management Server may push these updates to the WFAP on a periodic basis. The procedures above (Step 401 and Step 402) could be repeated to achieve this. Note that, if offline configuration events happen when WFAP is inactive, the Management Server may need to hold the new configured information until the WFAP becomes active.

Alternatively, in Step 402, the Management Server delivers the updated configuration information to the Fe-GW, and then the Fe-GW forwards this information to the WFAP. Moreover, the Management Server could receive an indication which indicates that the WFAP INE is completed, so the Management Server knows that the WFAP is operational to serve the mobile station (MS). And when the Management Server detects the WFAP is active, the Management Server delivers the configuration information to the WFAP. Step 401-Step 402 could be repeated, due to the change of the configuration information. For example, due to another offline configuration, the configuration information in WFAP and the one in Management System is required to be synchronized. Note that the configuration information mentioned in Step 401-Step 402 above could also be the CSG configuration Information.

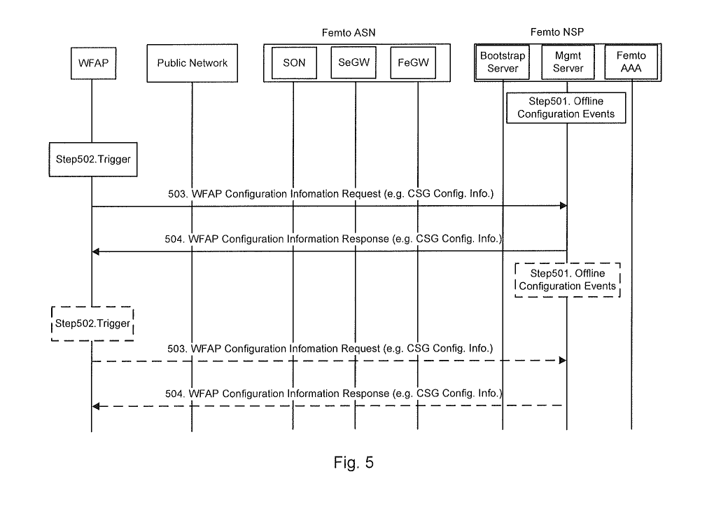

In FIG. 5, when the offline configuration happens, the Management Sever does not send the updated configuration information to the WFAP. Instead, based on some local event trigger to the WFAP, the WFAP will send a request for the updated configuration information to Management Sever.

Step 501 is identical to Step 401 as illustrated in FIG. 4.

In Step 502, some internal trigger (local event) may happen, e.g., handover, or timely manner.

In Step 503, when the WFAP receives the trigger, the WFAP sends a request to require the latest configuration information from the Management Server.

In Step 504, the Management Server may need to pick-up the Configuration Information that is configured “offline” for this WFAP. And the Management Server will then deliver this Configuration Information to update the Configuration Information stored in the WFAP.

Alternatively, in Step 503, the WFAP sends the request to the Fe-GW, and then the Fe-GW will then forward the request to the Management Server. In this case, in Step 504, the Management Server should respond the Configuration Information to the Fe-GW, and then the Fe-GW will then relay the information to the WFAP. Note that the trigger described above can be some events, e.g., a Handover request either from the mobile station or another base station, a Location Update request form the mobile station which is in the IDLE mode, and the like. When these events happen, if the WFAP considers the configuration information it has needs updated, then the WFAP will trigger the procedures as described by Step 503-Step 504. Note that Steps 501-504 (or Steps 502-504) could be repeated. Also note that, the configuration information mentioned in Steps 501-504 above could be the CSG configuration information.

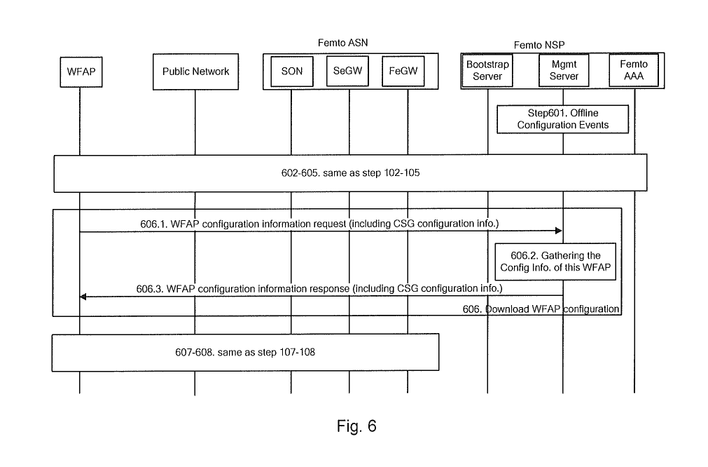

In FIG. 6, in Step 601, offline configuration events could happen any time when the WFAP is inactive (i.e., before WFAP performing INE and/or WFAP is not operational). One example of this configuration event could be the offline CSG configuration. However, the Management Server always stores the configured information in the management database.

Steps 602-605 is identical to Step 102-105 as illustrated in FIG. 1.

In Step 606.1, the WFAP connects to the management server. The WFAP may send its local information to the management server such as the IP address of WFAP, HW S/N, S/W version, location information, and the like. The WFAP can also obtain the latest configuration information from the Management Server in this Step.

In Step 606.2, consequently, the Management Server collects all the Configuration Information for updating the given WFAP, including those configured “offline”.

In Step 606.3, based on the provided information by WFAP (in Step 606.1), the Management Server provides the higher layer configuration parameters to the WFAP. Along with these parameters, either the FQDN or the IP address of the

SON server is returned to the WFAP. Furthermore, the Management Server may deliver the Offline Configuration Information mentioned in Step 606.2 to the WFAP to update the Configuration Information stored in the WFAP.

Steps 607-608 are identical to Steps 107-108 as illustrated in FIG. 1. The configuration information mentioned in Steps 601-608 above could be the CSG configuration information. Moreover, for all the scenarios described above (from FIG. 1 to FIG. 6), the Management Server can always deliver the entire CSG configuration information to the target WFAP due to some form of event trigger from the given WFAP or due to an explicit inquiry by the given WFAP.

Whenever WFAP is inactive or active, the offline configuration can happen at the SON Server. As a result, the new configured information may be stored in SON Server and the configuration may not be available for the WFAP at this point. Eventually, the configured information may need to be synchronized between the SON Server and the WFAP. One example of this configuration information could be the CSG configuration information. All the configuration information mentioned in this paragraph could be the CSG configuration information. The CSG configuration information at least includes a CSG member list for this WFAP and also could include other information related to CSG configuration.

Note that for all the scenarios (usage cases) described in FIGS. 1-6, the Management Server is responsible for the configuration management. Alternatively, it is possible for the SON server to support the same configuration management functions as described above. In such a case, the WFAP will request the SON server for the configuration information when needed; or the SON server, based on some external event trigger, sends the configuration information to the target WFAP when SON server discovers the configuration information of the WFAP has been updated, e.g., due to offline configuration. One example of this configuration event could be the CSG configuration and configuration information could be the CSG configuration information.

Whenever WFAP is inactive or active, the offline configuration can happen at the Femto-AAA. As a result, the new configured information may be stored in Femto-AAA and the configuration may not be available for the WFAP at this point. Eventually, the configured information may need to be synchronized between the Femto-AAA and the WFAP. One example of this configuration information could be the CSG configuration information. All the configuration information mentioned hereafter could be the CSG configuration information. The CSG configuration information at least includes a CSG member list for this WFAP and also could include other information related to CSG configuration.

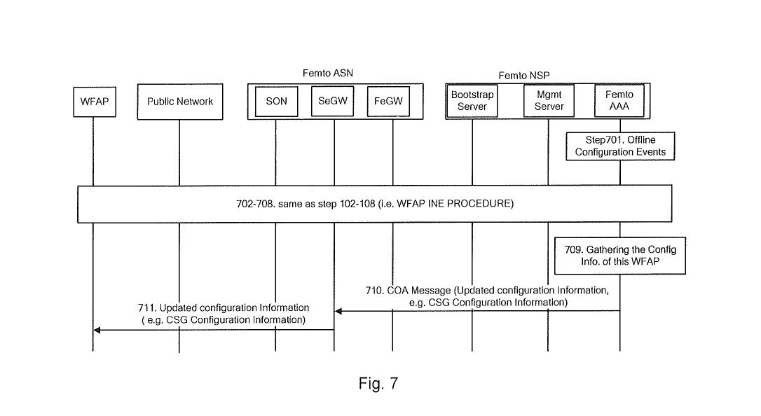

Referring to FIG. 7, in Step 701, offline configuration events could happen any time when the WFAP is active or inactive. One example of this configuration event could be the offline CSG configuration.

Steps 702-708 are identical to Steps 102-108 illustrated in FIG. 1.

In Step 709, Femto-AAA may need to pick-up the Configuration Information that is configured “offline” for WFAP. One example of this Configuration Information could be the CSG membership for this WFAP (e.g., CSG member list) or the other information related to CSG configuration. To enable the Femto-AAA to send the WFAP with the most recent configuration information, Femto-AAA may expect a trigger from the WFAP or from the Management Server when the WFAP INE is finished, Step 709 will then executed.

In Step 710, Femto-AAA delivers the Configuration Information mentioned in Step 709 to the Fe-GW/Se-GW, which holds the authenticator of the WFAP. The Femto-AAA could use RADIUS Change of Authorization (CoA) message or corresponding Diameter message (e.g., Diameter Re-Auth-Request (RAR) message) to deliver this Configuration Information.

In Step 711, the Fe-GW/Se-GW further delivers this Configuration Information to the WFAP to update the configuration information stored in the WFAP. The configuration information mentioned in Steps 701-711 above could be the CSG configuration information.

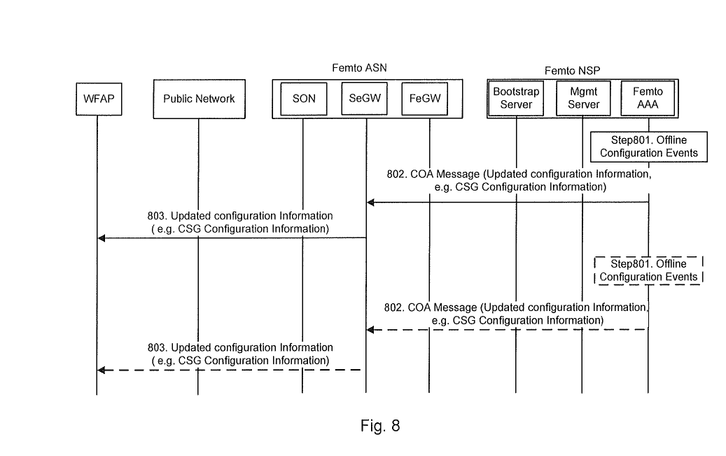

Referring to FIG. 8, in Step 801, offline configuration events could happen any time when the WFAP is active or inactive. One example of this configuration event could be the Offline CSG Configuration.

In Step 802, when the WFAP is active (i.e., after WFAP performing INE and is operational), the Femto-AAA uses RADIUS CoA message or Diameter RAR message to deliver the Configuration Information to Femto-GW/SeGW, which holds the authenticator of the WFAP in the timely manner to support the required operation.

In Step 803, the Fe-GW/Se-GW further delivers this Configuration Information to the WFAP to update the configuration information stored in the WFAP. Whenever periodic updates are needed from the Femto-AAA to the WFAP, the Femto-AAA may push these updates to the WFAP on a periodic basis. The procedures above (Steps 801-803) could be repeated to achieve this. For example, Steps 801-803 could be repeated, due to another offline configuration, the configuration information of the WFAP and the Femto-AAA become out-of-sync. Note that if offline configuration events happen when WFAP is inactive, the Femto-AAA may need to hold the new configured information until the WFAP becomes active. Note that in the Management Server/SON Server managed configuration scenario, when the configuration information changes (e.g., due to offline configuration), the Management Server/SON Server could send an indication to Femto-AAA to indicate this situation (e.g., via management plane). Then the Femto-AAA could use the RADIUS CoA message or Diameter RAR message as described in FIG. 8 to indicate to WFAP that its configuration information has changed. As a result, the WFAP will send a request to the Management Server/SON Server to require the updated configuration information, then the Management Server/SON Server will update the WFAP its configuration information using correspond message between them as described in FIG. 5. Note that, the configuration information mentioned in Steps 801-803 above could be the CSG configuration information.

Referring to Step 901, offline configuration events could happen any time when the WFAP is inactive (i.e., before WFAP performing INE and/or WFAP is not operational). The Femto-AAA will store the configured information locally. One example of this configuration event could be the offline CSG configuration.

Steps 902-904 are identical to Steps 102-104.

In Step 905, WFAP establishes IPSec tunnel with the Se-GW and WFAP authentication is performed. The Se-GW relays EAP messages to Femto-AAA for the authentication of the WFAP. The inner IP address is also assigned to WFAP by the default Se-GW. Note that in this Step, the Femto-AAA may send the latest Configuration Information to the Se-GW (e.g., Using AAA message), and then the Se-GW may forward this information to WFAP (e.g., Using IKEv2 message). The description as following: In Step 905.5, during the IPSec tunnel establishment phase, the Femto-AAA delivers the latest configuration information associated with this specific WFAP to the Se-GW (or Fe-GW), which holds the authenticator. The information can be transferred in RADIUS Access-Accept message or Diameter EAP-Answer message. In Step 905.6, the Se-GW delivers the configuration information received from Femto-AAA to WFAP in IKE-AUTH message. In Steps 905.8, if Se-GW did not deliver the configuration information to WFAP in Step 905.6, then the Se-GW can deliver this information to WFAP in IKE-AUTH message in this Step. Steps 906-908 may be identical to Step 106-108 as illustrated in FIG. 1.

Alternatively, in Step 905, Femto-AAA does not deliver the configuration information to WFAP via Se-GW (e.g., due to large amounts of information need deliver). Instead, the Femto-AAA sends an indication to WFAP via Se-GW to indicate the configuration information for the given WFAP is required to be updated (e.g., due to offline configuration happened before the WFAP performs INE). The Femto-AAA can use the same procedure specified in Step 905 above to deliver this indication. And based on this indication, the WFAP sends a request to the Management Server/SON Server to request to update its configuration information (refer to steps 106-108). The configuration information mentioned in Steps 901-908 above could be the CSG configuration information.

Although embodiments have been described with reference to a number of illustrative embodiments thereof to facilitate an understanding of the present invention, it will be apparent to those skilled in the art that modifications and variations may be made in the apparatuses and processes of the present invention without departing from the spirit or scope of the invention. It is intended that the present invention cover such modification and variations.

What is claimed:

1. A method of WiMAX Femto configuration management comprising:
delivering, by a server, configuration information to a WiMAX Femto Access Point, wherein the server is one of a management server, a self-organizing network server, or a Femto AAA server, and the configuration information is offline configuration information or configured offline,

2. The method of claim 1, further comprising retrieving, by the server, the configuration information.

3. The method of claim 1, further comprising receiving, by the server, a request for configuration information from the WiMAX Femto Access Point.

4. The method of claim 3, wherein the request for configuration information indicates completion of initial network entry.

5. The method of claim 1, further comprising:
accepting, by the server, a connection from the WiMAX Femto Access Point; and
gathering, by the server, the configuration information for the WiMAX Femto Access Point.

6. The method of claim 1, wherein the configuration information includes CSG configuration information.

7. The method of claim 1, wherein the delivering, by the server, the configuration information to the WiMAX Femto Access Point is carried out on a periodic basis.

8. The method of claim 1, further comprising holding, by the server, the configuration information until the WiMAX Femto Access Point becomes active.

9. A system for WiMAX Femto configuration management comprising:
means for delivering configuration information to a WiMAX Femto Access Point, wherein the configuration information is offline configuration information or configured offline.

10. The system of claim 9, further comprising means for retrieving the configuration information.

11. The system of claim 9, further comprising means for receiving a request for configuration information from the WiMAX Femto Access Point.

12. The system of claim 11, wherein the request for configuration information indicates completion of initial network entry.

13. The system of claim 9, further comprising:
means for accepting a connection from the WiMAX Femto Access Point; and
means for gathering configuration information for the WiMAX Femto Access Point, wherein the configuration information comprises offline configuration information.

14. The system of claim 9, wherein the configuration information includes CSG configuration information.

15. The system of claim 9, wherein the means for delivering the configuration information to the WiMAX Femto Access Point is configured to deliver the configuration information on a periodic basis.

16. The system of claim 9, further comprising means for holding the configuration information until the WiMAX Femto Access Point becomes active.

17. A method of WiMAX Femto configuration management comprising:
receiving, by a WiMAX Femto Access Point, configuration information from a server, wherein the server is one of a management server, a self-organizing network server, or a Femto AAA server, and the configuration information is offline information or configured offline for the WiMAX Femto Access Point.

18. The method of claim 17, further comprising requesting, by the WiMAX Femto Access Point, the configuration information.

19. The method of claim 17, wherein the configuration information includes CSG configuration information.

20. The method of claim 17, wherein receiving, by the WiMAX Femto Access Point, the configuration information includes periodically receiving the configuration information.

21. A system of WiMAX Femto configuration management comprising:
means for receiving configuration information from a server, wherein the server is a management server or a self-organizing network server, and the configuration information is offline information or configured offline.

22. The system of claim 21, further comprising means for requesting the configuration information.

23. The system of claim 21, wherein the configuration information includes CSG configuration information.

24. The system of claim 21, wherein the means for receiving is configured to periodically receive the configuration information.
